(19) United States
(12) Patent Application Publication
(10) Pub. No.: US 2002/0089941 A1
(43) Pub. Date: Jul. 11, 2002

(54) Network receiver utilizing sample management buffers

(76) Inventors: Chien-Meen Hwang, San Jose, CA (US); Hungming Chang, Sunnyvale, CA (US)

Correspondence Address: Mark D. Saralino, Renner, Otto, Boisselle & Sklar, LLP, 1621 Euclid Ave, 19th floor, Cleveland, OH, 44115, US

(21) Appl. No.: 09/755,857

(22) Filed: Jan. 5, 2001

(51) Int. Cl. H04L 12/54

(52) U.S. Cl. 370/292; 370/428; 370/206

(57) ABSTRACT

A network receiver is configured for receiving a modulated carrier signal representing a data frame from a network transmitter via a network medium. The receiver includes a sample management buffer to store incoming sample values of a transmitted rate in a buffer and a sample release circuit to release at a slower rate the stored sample values in buffer. An adaptive equalizer with a finite impulse response filter mixes the sample values, and a slicer reconstitutes original data transmitted.

### TECHNICAL FIELD

The present invention relates generally to network interfacing, and more particularly, to an apparatus and a method that utilizes sample management buffers to store sample values at a high sampling frequency and to release such sample values at a lower sampling frequency.

### BACKGROUND OF THE INVENTION

The transmission of various types of digital data between computers continues to grow in importance. One of the most predominant methods of transmitting such digital data includes the coding of digital data into low frequency baseband data signals and modulating these base data signals onto high frequency carrier signals. The high frequency carrier signals are then transmitted across network cable mediums, such as Ethernet cables, telephone wires, or other network mediums, to remote computing stations.

At the remote computing stations, the high frequency carrier signals must be received and demodulated to recover the original baseband data signals. If there were absolutely no distortion of the carrier signal across the network mediums, the received carrier signals would be identical in phase, amplitude, and frequency to the originally transmitted carrier signals. These theoretically perfect carrier signals could then be demodulated using known mixing techniques to recover the baseband data signals. The original data could then be recovered from the baseband data signals using known sampling algorithms.

However, the network topologies tend to distort the high frequency carrier signals. The number of branch connections and the different lengths of such branch connections can cause many reflections of the transmitted carrier signals. Such distortion is even more apparent in networks that utilize home telephone wiring cables as the network cable medium. This type of network cable medium is typically designed for transmitting plain old telephone system (POTS) signals in the 0.3-3.4 kilohertz frequency range and is not designed for transmission of high frequency carrier signals on the order of 7 Megahertz.

A typical approach for recovering transmitted data signals at a receiver operating in such an environment includes the use of an adaptive equalizer for filtering noise and distortion from the received carrier signals. In theory, an equalized signal should match the signal originally transmitted so that a slicer can accurately map the signal to defined constellation points to recover the original data.

Known equalizers comprise a complex finite impulse response (FIR) filter utilizing upward of 16 complex coefficients. Typically, each of the 32 real values comprising the 16 complex coefficients must be calculated to ten or more bits to maintain an adequate signal to noise ratio. The value of each coefficient is calculated for the particular distortion present during the short duration of time in which the carrier signal is transmitted and received. More particularly, the value of each coefficient is calculated based on characteristics of the carrier signal during the short duration of time in which a training sequence to a transmitted frame is received.

A problem associated with conventional receivers is that the coefficient calculation circuitry needed for calculating upward of 32 values within the short duration of time of the training sequence can require large and high-speed signal processing circuits that consume substantial power. Consequently, such circuits are not practical for use in battery-powered devices which have a limited power capacity. Further, large and high-speed circuits are typically expensive making them unsuitable for inexpensive consumer network devices such as home appliances, alarm systems, smoke detectors, door openers, and other consumer devices which no, or in the near future, may require inexpensive network access.

Therefore, based on recognized industry goals for size, cost, and power reductions, what is needed is a device and a method for filtering noise and distortion from a received carrier signal, and, more particularly for determining coefficient values efficiently and effectively that does not suffer the disadvantages of larger, more costly, and more powerful circuitries of conventional systems.

### SUMMARY OF THE INVENTION

A first aspect of the present invention is to provide a network receiver for recovering a frame of data transmitted at a first data rate on a network medium. A receiver circuit utilizes a training sequence portion of a data frame for calculating receiver parameters useful for recovering transmitted data from a subsequent data portion of the data frame. The receiver also comprises a buffer circuit storing a portion of data frame at the first data rate and releasing the portion to the receiver circuit at a second data rate, slower than the first data rate to effectively reduce the data rate input to the receiver circuit. The receiver circuit may include an equalizer utilizing a complex finite impulse response (FIR) filter to recover transmitted data and the receiver parameters are coefficients for the FIR filter.

An A/D converter may sample a modulated carrier, which may be a quadrature amplitude modulated carrier (QAM), and generate a sequence of sample values representing the modulated carrier at a first sampling frequency. The buffer circuit may operate to store data at the first data rate by storing samples at the first sampling frequency.

In a first embodiment, the buffer circuit may then release stored samples at a slower sampling frequency during the training sequence of the data frame and then release stored samples at a fast data rate, faster than the first data rate, during the data portion of the data frame. In a second embodiment, the buffer circuit may release stored samples at a slower sampling frequency during both the training sequence of the data frame and the data portion of the data frame. The first embodiment provides for no net increase in the time required to receive the data frame. The second embodiment increases the overall time required to receive the data frame.

In either embodiment, the receiver may further include a complex mixer which receives the sample values representing the modulated carrier from the A/D converter and generates a sequence of sample values representing an I channel data signal and a sequence of sample values representing a Q channel data signal. As such, the samples stored in the buffer circuit may include the sample values representing the I channel data signal and sample values representing the Q channel data signal. Further, a decimation filter may further reduce the sample frequency.

A second aspect of the present invention is to provide a method of receiving a frame of data transmitted at a first data rate on a network medium. The method comprises utilizing a training sequence portion of a data frame for calculating receiver parameters useful for recovering transmitted data from a subsequent data portion of the data frame. The method further comprises buffering the data frame at the first data rate and releasing the portion to the receiver circuit at a second data rate, slower than the first data rate to effectively reduce the data rate input to a receiver circuit. The receiver may filter the data frame utilizing an FIR filter to recover transmitted data, and the receiver parameters are coefficients for the filter.

The method may further include sampling the modulated carrier, which may be a QAM modulated carrier, to generating a sequence of sample values representing the modulated carrier at a first sampling frequency. The step of buffering at the first data rate includes storing samples at the first sampling frequency. The step of releasing at the second data rate includes releasing sample values at a slower sampling frequency corresponding to the second data rate.

In a first embodiment, the portion released to the receiver at the second data rate may include the training sequence and the method may further include a step of releasing samples at a fast data rate, faster than the first data rate, during the data portion of the frame of data. In a second embodiment, the portion released to the receiver at the second data rate may include both the training sequence and the data portion. Again, the first embodiment provides for no net increase in the duration of time required to receive a frame while the second embodiment increases the duration of time required to receive a frame.

In either embodiment, the method may further include mixing received sample values in a complex mixer to generate a sequence of sample values representing an I channel data signal and a sequence of sample values representing a Q channel data signal. The samples stored in the buffer may then include the sample values representing the I channel data signal and sample values representing the Q channel data signal. Further, a decimation step may be used to further reduce the sample frequency.

### BRIEF DESCRIPTION OF THE DRAWINGS

FIG. 1 is a block diagram of a local area network in accordance with one embodiment of this invention;

FIG. 2 is a block diagram of a receiver circuit useful in the local area network of FIG. 1 in accordance with one embodiment of this invention;

FIG. 3(a) graphical representation of a frame of data progressing into a sample management buffer useful in the receiver circuit of FIG. 2;

FIG. 3(b) is a graphical representation of a frame of data progressing out of a sample management buffer in accordance with one embodiment of this invention;

FIG. 3(c) is a graphical representation of a frame of data progressing out of a sample management buffer in accordance with a second embodiment of this invention;

FIG. 4(a) is a flow chart showing exemplary operation of a first embodiment of the sample management buffer useful in the receiver circuit of FIG. 2;

FIG. 4(a) is a flow chart showing exemplary operation of a second embodiment of the sample management buffer useful in the receiver circuit of FIG. 2.

### DESCRIPTION OF THE PREFERRED EMBODIMENTS

The present invention will now be described in detail with reference to the drawings. In the drawings, like reference numerals are used to refer to like elements throughout.

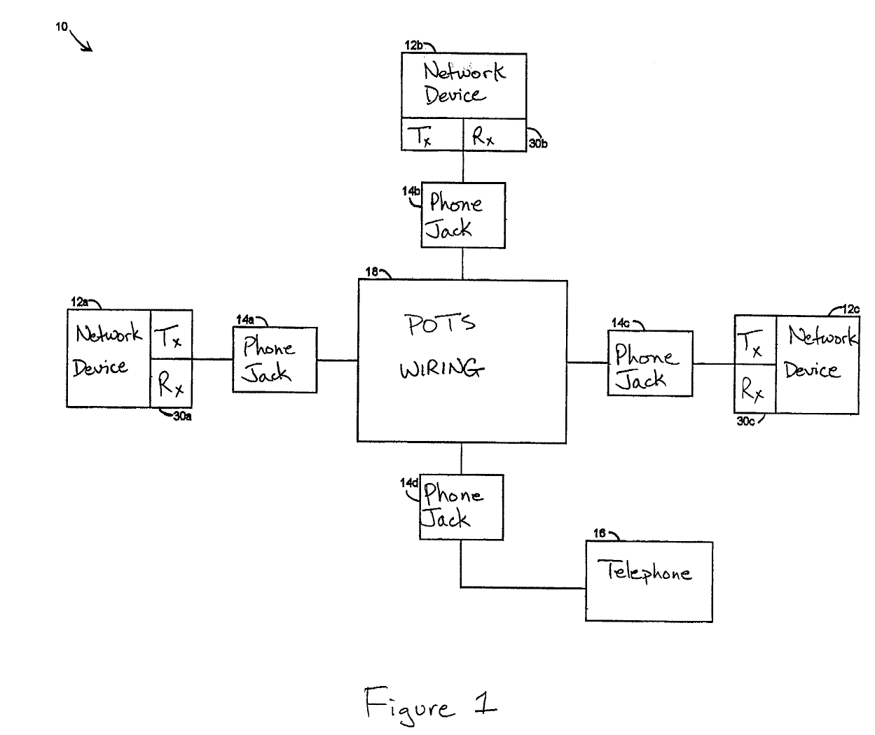

FIG. 1 is a diagram of a local area network 10 implemented in a home environment using a twisted pair network medium. The network 10 includes a plurality of network devices 12(a)-12(c) each connected to an RJ-11 phone jack 14(a)-14(d) respectively. In turn, each of the RJ-11 phone jacks 14(a)-14(c) are interconnected by plain old telephone system (POTS) twisted pair network wiring 18 (e.g. a network medium). The network 10 may also include a telephone 16 for making telephone calls via the network medium 18 while the network devices 12(a) 12(c) are transmitting and receiving network data over the network medium 18.

Each network device 12 may comprise a personal computer, printer, server, or other network compliant consumer device such as a smoke detector, appliance, door opener, or other small electronic device of the like. The network devices 12(a)-12(c) communicate by transmitting frames of data modulated onto an analog carrier signal. In the preferred embodiment, a quadrature amplitude modulation (QAM) scheme is used whereby data is modulated onto the carrier signal by varying both the amplitude and the phase of the carrier in accordance with a complex encoding constellation. The QAM scheme may comply with the Home Phoneline Network Alliance (HPNA) 2.0 standard, as promulgated by a consortium of network equipment providers including Advanced Micro Devices, Inc. of Sunnyvale, Calif., which provides for a 10-Mbit data rate.

Each network device 12(a)-12(c) includes a receiver circuit 30(a)-30(c) respectively for receiving QAM modulated frames of data transmitted on the network medium 18. As described previously, physical properties of the network medium 18 and the number of branch connections and the different lengths of such branches permit electromagnetic interference from other devices and cause reflections that significantly distort the transmitted QAM carrier signals. Therefore, the receiver circuit 30 must be able to recover data from such distorted carrier signals.

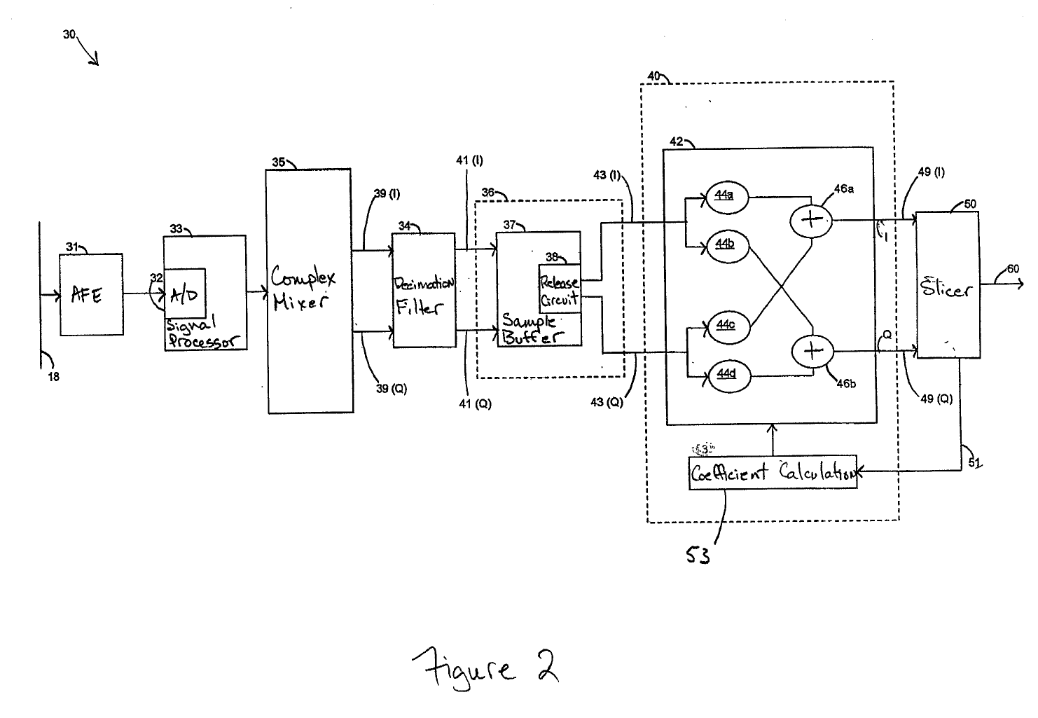

Referring to FIG. 2, a block diagram of the receiver circuit 30 useful for recovering data from a distorted QAM carrier signal is shown. The receiver circuit 30 includes an analog front end 31, coupled to the POTS network medium 18, which operates to detect and appropriately amplify the modulated carrier signal to utilize the full dynamic range of an A/D converter 32. The A/D converter 32 samples the amplified modulated carrier signal at a sampling clock frequency to generate a series of sample values, representing the carrier signal in digital format. It should be appreciated that Nyquist criteria requires a sampling frequency of twice the carrier frequency, however, in practice a sampling frequency greater than that required by Nyquist criteria is used. Typically, a sampling frequency on the order of four or more times the frequency of the carrier signal is used. In the preferred embodiment, the A/D converter 32 is a 10-bit analog-to-digital converter driven by a 32 MHz clock such that the digital carrier signal is a sequence of 10-bit sample values occurring at a 32 MHz sampling rate.

The 32 MHz sample values are then input to a complex mixer 35 which operates to mix down the carrier frequency signal into a separate baseband I channel signal and a separate baseband Q channel signal. As such the output of the complex mixer 35 on line 39(I) is a baseband I channel signal represented by a 32 MHz sequence of samples, and the output of the complex mixer 35 on line 39(Q) is a baseband Q channel signal represented by a 32 MHz sequence of samples. The complex mixer 35 may be implemented using any known techniques for recovering a baseband I channel signal and a baseband Q channel signal from a modulated carrier. Further it is contemplated that the complex mixer 35 may include a plurality of mixers for achieving the required function.

Lines 39(I) and 39(Q) are input to a decimation filter 34 which in the preferred embodiment is an 8-to-1 decimation filter. The 8-to-1 decimation filter 34 operates to reduce the sample frequency of each of the baseband I channel signal and the baseband Q channel signal from 32 MHz to 4 MHz. Therefore, the output of the decimation filter 34 on line 41(I) is a baseband I channel signal represented by a 4 MHz sample frequency and the output of the decimation filter on line 41(Q) is a baseband Q channel signal represented by a 4 MHz sample frequency. In the preferred embodiment, the decimation filter operates in accordance with the teaching of U.S. patent application Ser. No. 09/510,775 filed on Feb. 23, 2000 and assigned to the same assignee as the present invention. Such decimation filter has an improved signal to noise ratio at the output of the filter by synchronizing the decimation phase with the phase of the base band data signal. However, this invention is not limited to the use of such decimation filter and other decimation filter systems will suffice for the purposes of this invention.

Lines 41(I) and 41(Q) are input to a sample management buffer 36. The sample management buffer 36 comprises a sample buffer 37 for storing the samples representing the baseband I channel and Q channel signals at the 4 MHz sample frequency. The sample management buffer 36 also includes a sample release circuit 38 which operates to release the samples from the sample buffer 37 at a slower sampling rate on lines 43(I) and 43(Q). A more detailed description of the sample management buffer 36 will be discussed later herein.

Lines 43(I) and 43(Q) are coupled to an equalizer 40. The equalizer 40 receives the sample values representing the baseband I channel and Q channel signals at the slower sampling rate and functions to remove distortions caused by propagation of the modulated carrier signal across the POTS network 18 (FIG. 1) and generate equalized baseband signals I and Q on lines 49(I) and 49(Q) respectively. Thereafter, lines 49(I) and 49(Q) are input to a slicer 50 which functions to map the baseband I channel and Q channel signals to a sequence of defined constellation points to recover the data originally transmitted and output such data in a serial format on line 60.

The equalizer 40 includes a complex finite impulse response (FIR) filter 42 including four multipliers 44(a)-44(d) arranged in accordance with complex FIR principals to filter a single utilizing 16 complex coefficients. The outputs of multipliers 44(a) and 44(c) are added in adder 46(a) to generate the equalized baseband I channel signal on line 49(I). The output of multiplier 44(b) is subtracted from the output of multiplier 44(d) in adder 46(b) to generate the equalized baseband Q channel signal on line 49(Q).

As discussed previously, in the HPNA 2.0 environment, the complex FIR filter 42 requires 16 complex coefficients for operation and each of the 32 values comprising the 16 complex coefficients is a value with 10 or more bits of accuracy to maintain an adequate signal to noise ratio. The value of each of the coefficients must be determined such that, in the aggregate, the complex FIR filter 42 functions to compensate for the distortions occurring in the network. Further, because the distortions affecting any particular signal is a function of the physical location of the transmitter and receiver on the POTS network 18 and is a function of the noise affecting the POTS network 18 during the duration of time in which the signal is transmitted, the coefficients best suited for compensating for the distortions for a particular signal may be fundamentally different than those best suited for compensating the distortions for a signal transmitted by a different transmitter and/or during a different time period.

For example, referring briefly back to FIG. 1, the coefficients adapted for receiving a signal at the receiver 30(c) from network device 12(b) may be fundamentally different than the coefficients adapted for receiving a signal from network device 12(a). Further, the coefficients adapted to receive a signal from network device 12(b) during one time period may not be suitable to receive a signal from network device 12(b) during a different time period in which electromagnetic interference affecting the POTS network 18 has changed. Therefore, the equalizer 40 further includes coefficient calculation circuitry 53 for calculating a complete set of 44 coefficients for each data frame to accommodate for the distortion present during the short duration of time in which such data frame is received.

The coefficient calculation circuitry 53 must calculate the complete set of 44 coefficients during the short duration of time during which a predetermined training sequence is received. More specifically, a feedback signal 51 from the slicer 50 represents the variance between a received data coordinate from the equalizer 40 on lines 49(I) and 49(Q) and a defined constellation point to which the received data coordinate maps. The coefficient calculation circuitry 53 uses the feedback signal to calculate coefficients for the complex filter 42 which enables the complex filter 42 to shape, or equalize the signal, to reduce the variance.

As discussed previously, the coefficient calculation circuitry 53 must operate to calculate all 32 coefficient values within the short duration of time in which the training sequence is received such that the complex filter 42 is able to adequately equalize the subsequent samples representing the transmitted data. When operating in the HPNA 2.0 environment, large and costly signal processing circuits which require substantial power would typically be required.

However, the operation of the sample management buffer 36 operates to reduce the sampling frequency (and corresponding reduce the data rate) input to the equalizer, by buffering the samples and releasing at the slower sampling frequency, and thus increasing the duration of time of the training sequence during which the coefficient calculation calculates the coefficients. As such, fewer operations per second are required which enables for receiver designs with cheaper and less complex circuits and/or slower circuits which consume less power.

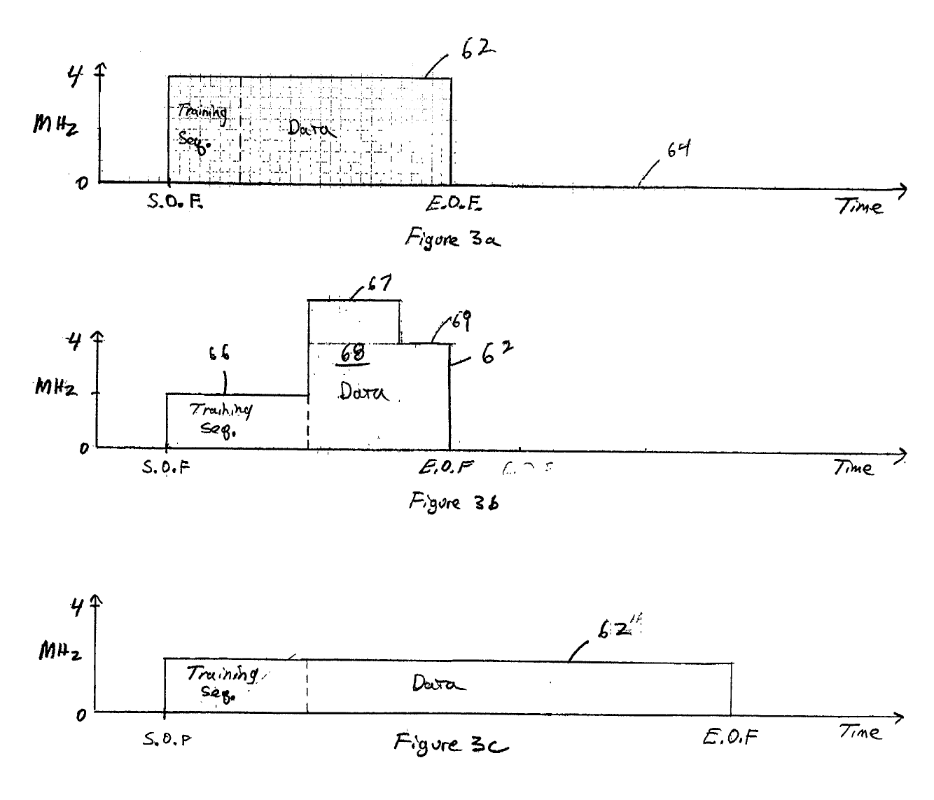

Referring to FIG. 3(a) in conjunction with FIG. 2, the progression of a data frame input to the sample management buffer 36 is shown. More specifically, the start of frame (SOF) point and end of frame (EOF) point on the time axis 64 represent the duration of time during which samples (at a 4 MHz sampling rate) are input to the sample management buffer 36 on lines 41(I) and 41(Q).

Referring to FIG. 3(b) in conjunction with FIG. 2, the progression of a data frame out of the sample management buffer 36 for a first embodiment of operation is shown. During a training sequence portion 66 of data frame 62, the data rate out of the sample management buffer on lines 43(I) and 43(Q) is slowed to the slower data rate to increase the duration of time during which the coefficient calculation circuitry 53 must calculate all of the coefficients. Thereafter, during a first part 67 of a data portion 68, the data rate out of the sample management buffer on lines 43(I) and 43(Q) is increased to a fast data rate which is in excess of the 4 MHz rate at which data progresses into the sample management buffer. Then, during a second portion 69 of the data portion 68 of the data frame 62, the data rate out of the sample management buffer on lines 43(I) and 43(Q) is decreased back to the 4 MHz data rate. The transition between the first portion 67 and the second portion 69 occurs when the samples accumulated in the sample management buffer are exhausted.

It should be appreciated that the overall time required to receive data frame 62, as represented by the time duration between SOF and EOF, is not increased. The increase in the data rate out of the sample management buffer during the first portion 67 compensates for the decreased rate during the training sequence 66.

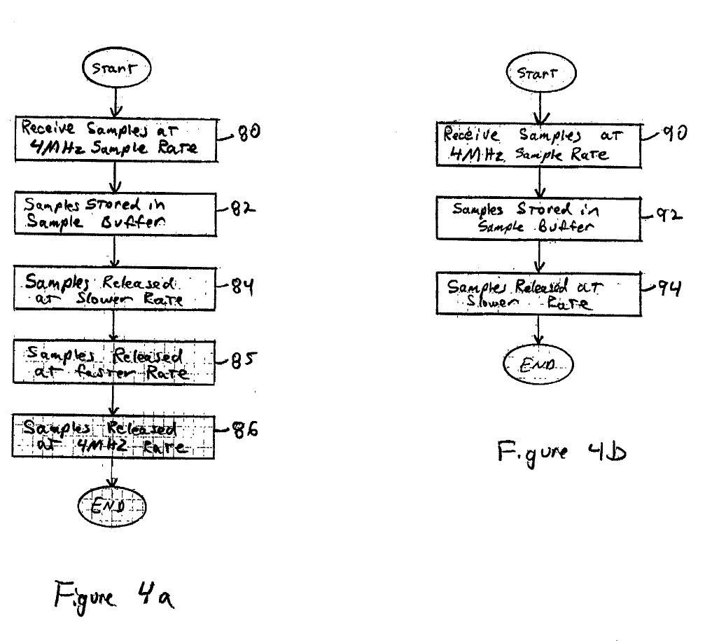

Referring to the flow chart of FIG. 4a in conjunction with FIG. 2, operation of the sample management buffer 36 operating in the first embodiment is shown. At step 80, the sample management buffer 36 functions to receive incoming samples representing the baseband I channel and Q channel signals on lines 41(I) and 41(Q) respectively at the 4 MHz sampling rate. At step 82, the samples are stored in the sample buffer 37. At step 84, the sample release circuit 38 retrieves samples representing the baseband I channel and Q channel signals from the sample buffer 37 and releases such values on lines 43(I) and 43(Q) at the slower sample rate for calculation of the training sequence. At step 85, the sample release circuit 38 releases samples at the fast data rate (greater than 4 MHz). Then, when the accumulated samples in the sample management buffer 36 are exhausted, the sample management buffer progresses to step 86 wherein the sample release circuit 38 releases the remainder samples of the buffered data frame at the received 4 MHz sampling rate. It should be appreciated that various circuit structures may be used for achieving the functionality described. Such circuit structures include a micro controller managing the storing and retrieving of samples from a random access memory or a first in first out (FIFO) buffer.

As previously discussed, the above described embodiment provides for no net increase in the time required to receive a frame of data while providing for a slower data rate through an equalizer during a training sequence for coefficient calculation. However, in certain environments where the device is not receiving frames in a rapid succession, an overall time increase in the time required to receive a frame of data may not be significant.

Referring to FIG. 3(c) in conjunction with FIG. 2, the progression of a data frame out of the sample management buffer 36 for a second embodiment of operation is shown. In this second embodiment, the data rate out of the sample management buffer on lines 43(I) and 43(Q) is slowed to the slower data rate for both the training sequence portion 66 and the data portion 68 of the data frame 62. As such the duration of time during which the coefficient calculation circuitry 53 must calculate all of the coefficients is increased and the sample release circuit 38 is simplified because it can be designed to operate at a single speed only. The drawback of course is that the overall time required to receive data frame 62 as represented by the time duration between SOF and EOF is further increased. However, in an environment where the device is not receiving frames in a rapid succession, the overall time increase is not a significant detriment compared to the cost savings.

Referring to the flow chart of FIG. 4b in conjunction with FIG. 2, operation of the sample management buffer 36 operating in the second embodiment is shown. At step 90, the sample management buffer 36 functions to receive incoming samples representing the baseband I channel and Q channel signals on lines 41(I) and 41(Q) respectively at the 4 MHz sampling rate. At step 92, the samples are stored in the sample buffer 37. At step 94, the sample release circuit 38 retrieves samples representing the baseband I channel and Q channel signals of the data frame from the sample buffer 37 and releases the samples of the data frame on lines 43(I) and 43(Q) at the slower sample rate for the entire duration of the data frame. Again, it should be appreciated that various circuit structures may be used for achieving the functionality described. Such circuit structures include a micro controller managing the storing and retrieving of samples from a random access memory or a first in first out (FIFO) buffer.

Although the invention has been shown and described with respect to certain preferred embodiments, equivalents and modifications will occur to others skilled in the art upon the reading and understanding of the specification. While the exemplary embodiment is directed towards utilizing sample management buffers to lower the rate of sampling values for which a sample equalizer receives to equalize modulated signals, other techniques may be used to reduce the sampling frequency to achieve similar effects. Additionally, while the exemplary embodiment is directed to HPNA QAM modulation, the invention is as readily useful in other environments wherein a training sequence is used for calculating receiver parameters regardless of the modulation technique. The present invention includes all such equivalents and modifications, and is limited only by the scope of the following claims

What is claimed is:

1. A network receiver for recovering a frame of data transmitted at a first data rate on a network medium, the receiver comprising:
(a) A receiver circuit utilizing a training sequence portion of a data frame for calculating receiver parameters useful for recovering transmitted data from a subsequent data portion of the data frame; and
(b) A buffer circuit storing a portion of data frame at the first data rate and releasing the portion to the receiver circuit at a second data rate, slower than the first data rate to effectively reduce the data rate input to the receiver circuit.

2. The network receiver of claim 1, wherein the receiver circuit is an equalizer utilizing a complex finite impulse response filter to recover transmitted data and the receiver parameters are coefficients for the filter.

3. The network receiver of claim 2, further including an A/D converter sampling a modulated carrier and generating a sequence of sample values representing the modulated carrier at a first sampling frequency and the buffer circuit operates to store data at the first data rate by storing samples at the first sampling frequency and releases samples at a slower sampling frequency corresponding to the second data rate.

4. The network receiver of claim 3, wherein the buffer circuit releases samples at a slower sampling rate during a training sequence of the frame of data and releases samples a faster data rate, which is faster than the first data rate, during a data portion of the frame of data.

5. The network receiver of claim 4, further including a complex mixer receiving the sample values from the AND converter and generating a sequence of sample values representing an I channel data signal and a sequence of sample values representing a Q channel data signal, and the samples stored in the buffer circuit include the sample values representing the I channel data signal and sample values representing the Q channel data signal.

6. The network receiver of claim 5, wherein the data frame is transmitted on the network medium utilizing quadrature amplitude modulation.

7. The network receiver of claim 6, further including a decimation filter to further reduce the sample frequency.

8. The network receiver of claim 3, wherein the buffer circuit releases samples at a slower sampling rate during a training sequence of the frame of data and during a data portion of the frame of data.

9. The network receiver of claim 8, further including a complex mixer receiving the sample values from the AND converter and generating a sequence of sample values representing an I channel data signal and a sequence of sample values representing a Q channel data signal, and the samples stored in the buffer circuit include the sample values representing the I channel data signal and sample values representing the Q channel data signal.

10. The network receiver of claim 9, wherein the data frame is transmitted on the network medium utilizing quadrature amplitude modulation.

11. The network receiver of claim 10, further including a decimation filter to further reduce the sample frequency.

12. A method of receiving a frame of data transmitted at a first data rate on a network medium, method comprising:
(a) utilizing a training sequence portion of a data frame for calculating receiver parameters useful for recovering transmitted data from a subsequent data portion of the data frame; and
(b) buffering a portion of data frame at the first data rate and releasing the portion to the receiver circuit at a second data rate, slower than the first data rate to effectively reduce the data rate input to a receiver circuit.

13. The method of receiving a frame of data of claim 12, further including filtering the data frame utilizing a finite impulse response filter to recover transmitted data and the receiver parameters are coefficients for the filter.

14. The method of receiving a frame of data of claim 13, further including sampling the modulated carrier to generating a sequence of sample values representing the modulated carrier at a first sampling frequency and the step of buffering at the first data rate includes storing samples at the first sampling frequency and the step of releasing at the second data rate includes releasing sample values at a slower sampling frequency corresponding to the second data rate.

15. The method of receiving a frame of data of claim 14, wherein the step of releasing at the second data rate occurs during a training sequence of the frame of data and the method further includes a step of releasing sample values at a fast sampling frequency, which is faster than the first sampling frequency, during a data portion of the frame of data.

16. The method of receiving a frame of data of claim 15, further including mixing received sample values in a complex mixer to generate a sequence of sample values representing an I channel data signal and a sequence of sample values representing a Q channel data signal, and the samples stored in the buffer circuit include the sample values representing the I channel data signal and sample values representing the Q channel data signal.

17 The method of receiving a frame of data of claim 16, wherein the data frame is transmitted on the network medium utilizing quadrature amplitude modulation.

18. The method of receiving a frame of data of claim 17, further including a decimation filter to further reduce the sample frequency.

19. The method of receiving a frame of data of claim 14, wherein the step of releasing at the second data rate occurs during a training sequence of the frame of data and during a data portion of the frame of data.

20. The method of receiving a frame of data of claim 19, further including mixing received sample values in a complex mixer to generate a sequence of sample values representing an I channel data signal and a sequence of sample values representing a Q channel data signal, and the samples stored in the buffer circuit include the sample values representing the I channel data signal and sample values representing the Q channel data signal.

21. The method of receiving a frame of data of claim 20, wherein the data frame is transmitted on the network medium utilizing quadrature amplitude modulation.

22. The method of receiving a frame of data of claim 217, further including a decimation filter to further reduce the sample frequency.
